(19) United States
(12) Patent Application Publication
(10) Pub. No.: US 2021/0053797 A1
(43) Pub. Date: Feb. 25, 2021

(54) GUIDE RAIL BRACKET ASSEMBLY

(71) Applicant: Otis Elevator Company, Farmington, CT (US)

(72) Inventors: Jean-Emile Rocher, Lorris (FR); Vincent Lopez, Gien (FR)

(21) Appl. No.: 16/835,585

(22) Filed: Mar. 31, 2020

(30) Foreign Application Priority Data
Aug. 23, 2019 (EP) 19315101.6

(51) Int. Cl. B66B 7/04; B66B 11/00

(52) U.S. Cl. CPC B66B 7/04; B66B 11/0005

(57) ABSTRACT

A guide rail bracket assembly, for connecting a car guide rail to a pair of left and right counterweight guide rails in an elevator system, includes a guide rail bracket for horizontally connecting the car guide rail to the pair of left and right counterweight guide rails. The guide rail bracket comprises a first end portion for attachment to the left counterweight guide rail, a second end portion for attachment to the right counterweight guide rail, and an intermediate portion for attachment to the car guide rail. The guide rail bracket assembly further comprises a first interface bracket for attaching the first end portion to the left counterweight guide rail, a second interface bracket for attaching the second end portion to the right counterweight guide rail, and a third interface bracket for attaching the intermediate portion to the car guide rail.

### FOREIGN PRIORITY

This application claims priority to European Patent Application No. 19315101.6, filed Aug. 23, 2019, and all the benefits accruing therefrom under 35 U.S.C. § 119, the contents of which in its entirety are herein incorporated by reference.

### TECHNICAL FIELD

The present disclosure relates generally to the field of elevator systems, and more particularly to assemblies and methods for guide rail installation in elevator systems.

### BACKGROUND

Current elevator systems use guide rails to provide a track upon which the elevator car and/or counterweight may travel. According to safety standards such as EN81, the car and counterweight shall each be guided by at least two rigid steel guide rails when a safety gear is employed to stop the car and counterweight in the event of overspeeding or breaking of the suspension. Depending on the layout of the elevator system, the two counterweight guide rails may be connected to one of the car guide rails by a guide rail bracket. The guide rail bracket helps to maintain a desired spacing between the guide rails. The guide rails and vertical distance between guide rail brackets in an elevator system are chosen so as to ensure the guide rails can withstand the loads and forces imposed on them.

In a typical elevator system, guide rails having a standard length (e.g. 2.5 or 5 m) are installed. Depending on the height of the hoistway, multiple guide rails are usually connected end-to-end to achieve a desired overall height. Connecting plates known as “fishplates” are commonly bolted to adjacent guide rails to join the guide rails vertically together.

It will therefore be appreciated that there are multiple components to be handled and fixed together when installing the guide rails for an elevator system. It would be desirable to reduce the number of components involved when installing an elevator system.

### SUMMARY

According to the present disclosure, there is provided guide rail bracket assembly for connecting a car guide rail to a pair of left and right counterweight guide rails in an elevator system, the guide rail bracket assembly comprising: a guide rail bracket for horizontally connecting the car guide rail to the pair of left and right counterweight guide rails, the guide rail bracket comprising a first end portion for attachment to the left counterweight guide rail, a second end portion for attachment to the right counterweight guide rail, and an intermediate portion for attachment to the car guide rail; a first interface bracket for attaching the first end portion to the left counterweight guide rail, a second interface bracket for attaching the second end portion to the right counterweight guide rail, and a third interface bracket for attaching the intermediate portion to the car guide rail; wherein at least one of the first, second and third interface brackets forms a connecting plate for vertically connecting together adjacent guide rails.

In other words, at least one interface bracket has an integrated fishplate function provided by the connecting plate. This means that a cost reduction may be achieved by employing such a guide rail bracket assembly when installing adjacent guide rails for an elevator system, especially for mid- and high-rise buildings (and associated hoistways), as fewer components are required when installing the guide rails in the hoistway.

In at least some examples, two or three of the interface brackets each provides such an integrated fishplate function. In at least some examples, each of the first, second and third interface brackets forms a connecting plate for vertically connecting together adjacent guide rails.

In at least some examples, in addition or alternatively, the connecting plate comprises at least four openings, each opening arranged to receive a through fastener for direct attachment of the left counterweight guide rail, right counterweight guide rail or car guide rail to its respective interface bracket. For example, two openings may receive a through fastener for attachment of a lower guide rail and two openings may receive a through fastener for attachment of a lower guide rail, the upper and lower guide rails being adjacent guide rails vertically connected together by the connecting plate.

In at least some examples, in addition or alternatively, the connecting plate comprises a row of at least four openings arranged to receive a respective through fastener. This enables the interface bracket to be fixedly attached to the base of a corresponding guide rail by two through fasteners in a row, for safety reasons. Preferably the connecting plate comprises two rows of at least four openings arranged to receive a respective through fastener. This enables the interface bracket to be fixedly attached to the base of a corresponding guide rail by two through fasteners in a row, on either side of the blade. The guide rail bracket assembly may optionally further comprise through fasteners for the connecting plates. Appropriate through fasteners may, for example, consist of screws, bolts or other known attachment means.

The first, second and third interface brackets may be suitably shaped to interface with a corresponding guide rail while also providing an integrated fishplate function.

In at least some examples, in addition or alternatively, the first and second interface brackets are L-shaped, comprising a first plate arranged to face the guide rail bracket and a second plate, substantially orthogonal to the first plate, the second plate forming the connecting plate and arranged to face a base of the left or right counterweight guide rail. Optionally, the first and second interface brackets further comprise a third plate, substantially orthogonal to the first plate and the second plate, the third plate extending away from the second plate that forms the connecting plate. Further optionally, the third plate comprises one or more openings for through fasteners to attach the first/second interface bracket to a support bracket.

In at least some examples, in addition or alternatively, the guide rail bracket assembly may further comprise a support bracket configured to fixedly mount the guide rail bracket to a wall. In at least some examples, there are support brackets at both ends of the guide rail bracket. In at least some examples, the support bracket comprises a first support bracket attached to the first interface bracket and a second support bracket attached to the second interface bracket.

In at least some examples, in addition or alternatively, the third interface bracket is U-shaped, comprising a base plate that forms the connecting plate and is arranged to face the guide rail bracket, and first and second side flanges on opposed sides of the base plate that space the base plate away from the guide rail bracket. In this U-shaped interface bracket, the base plate faces the guide rail bracket as part of a compact layout but, as the base plate forms the connecting plate, there must be space provided to be able to fasten the base plate to adjacent car guide rails. The side flanges ensure adequate space for through fasteners by spacing the base plate away from the guide rail bracket. Optionally, the first and second side flanges extend away from the base plate and terminate in first and second fastening plates arranged to be fastened to the guide rail bracket. In such examples, the base plate fastens to the car guide rails and the fastening plates fasten to the guide rail bracket, meaning that there are different plates for different sets of through fasteners. This helps to spread loads applied to the interface bracket and assists with ease of installation.

There is further disclosed a guide rail assembly comprising a guide rail bracket assembly according to any of the examples above, a left counterweight guide rail attached to the first interface bracket, a right counterweight guide rail attached to second interface bracket, and a car guide rail attached to the third interface bracket, wherein the first, second and third interface brackets are attached to the guide rail bracket.

In at least some examples, at least one of the left counterweight guide rail, right counterweight guide rail and car guide rail is directly attached to its respective interface bracket by a through fastener. This means that intervening clamps or other fastening arrangements may not be required, so there are fewer components required to fasten the guide rails to the guide rail bracket.

Such a guide rail assembly may have more than one physical state, e.g. one state designed for ease of transportation and another state used for installation.

In at least some examples, the guide rail assembly has a pre-assembled state, wherein the first, second and third interface brackets are attached to the guide rail bracket and to the guide rails such that the guide rails run substantially parallel to the guide rail bracket. This pre-assembled state is very compact and can make transportation easier and/or more cost effective.

In at least some examples, in addition or alternatively, the guide rail assembly has an assembled state, wherein the first, second and third interface brackets are attached to the guide rail bracket and to the guide rails such that the guide rails run substantially perpendicular to the guide rail bracket. This assembled state corresponds to the guide rail assembly in situ (e.g. in a hoistway) when installing an elevator system.

In at least some examples, in addition or alternatively, the guide rail assembly comprises: adjacent first and second left counterweight guide rails attached to the first interface bracket so as to be vertically connected together; and/or adjacent first and second right counterweight guide rails are attached to the second interface bracket so as to be vertically connected together; and/or adjacent first and second car guide rails are attached to the third interface bracket so as to be vertically connected together.

It will be appreciated that vertically adjacent guide rails may be touching end-to-end or the connecting plate may provide a gap between vertically adjacent guide rails e.g. allowing for building settling and thermal expansion/contraction, without causing buckling of the guide rail. The connecting plate may be as described in US 2018/009633, the contents of which are hereby incorporated by reference.

According to the present disclosure, there is further provided a method of installing guide rails in an elevator system, comprising: providing a guide rail assembly in a pre-assembled state, the guide rail assembly comprising a guide rail bracket attached to first, second and third interface brackets, the first interface bracket attached to a left counterweight guide rail, the second interface bracket attached to a right counterweight guide rail, and the third interface bracket attached to a car guide rail, wherein the guide rail bracket and the guide rails are attached to the interface brackets such that the guide rails run substantially parallel to the guide rail bracket; and assembling the guide rail bracket to horizontally connect the car guide rail to the left and right counterweight guide rails by further attaching the guide rail bracket to the first, second and third interface brackets and further attaching the guide rails to the first, second and third interface brackets such that the guide rails run substantially perpendicular to the guide rail bracket.

In various examples, the method comprises using through fasteners to directly attach and/or further attach one or more of the left counterweight guide rail, right counterweight guide rail or car guide rail to its respective interface bracket.

In examples of such a method, providing the guide rail assembly in a pre-assembled state may optionally include hoisting the guide rail assembly to a desired vertical position before assembling the guide rail bracket to horizontally connect the car guide rail to the left and right counterweight guide rails.

### DRAWING DESCRIPTION

Some examples of this disclosure will now be described, by way of illustration only, and with reference to the accompanying drawings, in which:

FIG. 1a is a perspective view of a guide rail bracket and FIG. 1b is a perspective view of a guide rail assembly in an elevator system according to an example of the prior art;

FIG. 2 is a perspective view of a guide rail assembly in an elevator system according to an example of the present disclosure;

FIGS. 3a and 3b are perspective and top views of the guide rail assembly of FIG. 2 in a pre-assembled state; and

FIG. 4 is a front view of the guide rail assembly of FIG. 2 in an assembled state with adjacent guide rails vertically connected together.

### DETAILED DESCRIPTION

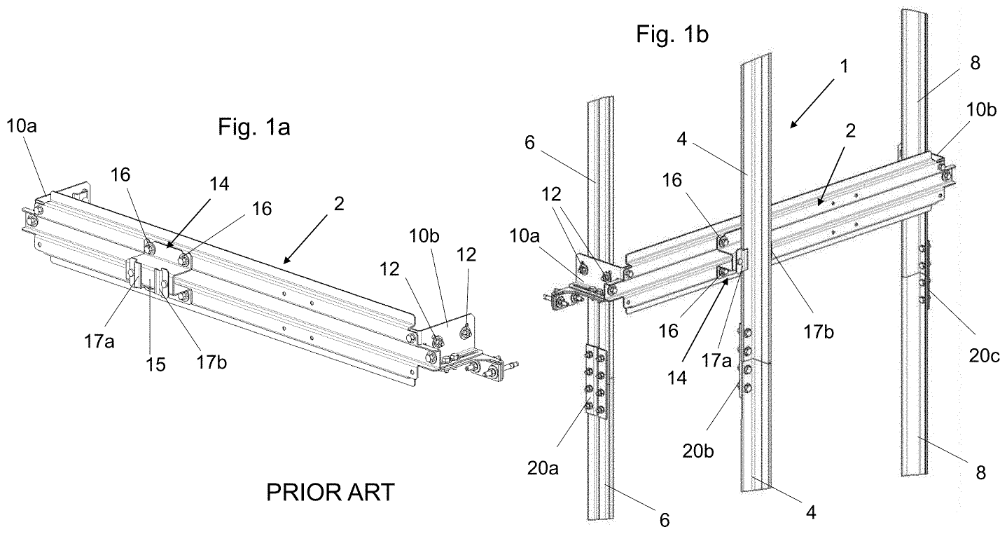

In an example of the prior art, as seen in FIGS. 1a and 1b, a guide rail assembly 1 comprises a guide rail bracket 2 horizontally connecting a car guide rail 4 to a pair of left and right counterweight guide rails 6, 8. The guide rail bracket 2 is attached to the car guide rail 4 by a clamping bracket 14. As seen most clearly in FIG. 1a, the clamping bracket 14 includes a shim 15 and a pair of clamps 17a, 17b, each attached to the shim 15 by a screw. The shim 15 has two rows of openings for through fasteners 16 with two through fasteners 16 in each row to fasten the clamping bracket 14 to the guide rail bracket 2. The car guide rail 4 is restrained between the clamps 17a, 17b, as seen in FIG. 1b, i.e. held back against the shim 15. by being pinched between the clamps 17a, 17b. The guide rail bracket 2 is attached to the left counterweight guide rail 6 by an interface bracket 10a and to the right counterweight guide rail 8 by a mirror image interface bracket 10b. Each interface bracket 10a, 10b has only two openings receiving through fasteners 12 that attach the interface bracket 10a, 10b to a pair of clamps (not seen) that pinch the base of the corresponding counterweight guide rail 6, 8 (in a similar manner to the clamps 17a, 17b described above).

As shown in FIG. 1b, the way that adjacent guide rails are connected together vertically in the prior art is by fishplates that span the joint. FIG. 1b shows a fishplate 20a vertically connecting together adjacent left counterweight guide rails 6, another fishplate 20b vertically connecting together adjacent car guide rails 4, and another fishplate 20c vertically connecting together adjacent right counterweight guide rails 8. When installing the guide rails 4, 6, 8 in an elevator system, each of the component parts seen in FIGS. 1a and 1b must be provided and assembled together.

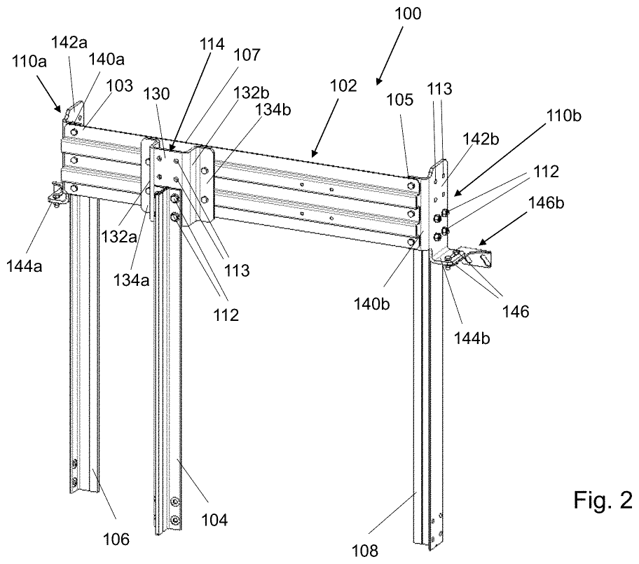

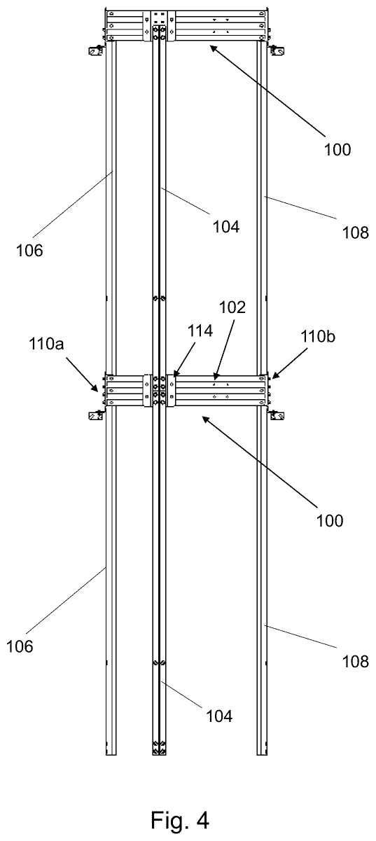

In an example of the present disclosure, as seen in FIGS. 2-4, a guide rail assembly 100 comprises a guide rail bracket 102 horizontally connecting a car guide rail 104 to a pair of left and right counterweight guide rails 106, 108. A first end portion 103 of the guide rail bracket 102 is attached to the left counterweight guide rail 106 by a first interface bracket 110a and a second end portion 105 of the guide rail bracket 102 is attached to the right counterweight guide rail 108 by a mirror image second interface bracket 110b. An intermediate portion 107 of the guide rail bracket 102 is attached to the car guide rail 104 by a third interface bracket 114. In this example, each interface bracket 110a, 110b, 114 has two rows of four openings 113 receiving through fasteners 112 that attach the interface bracket 110a, 110b, 114 directly to the base of the corresponding guide rail 104, 106, 108. As is seen most clearly for the third interface bracket 114, two openings in each row receive through fasteners 112 for a first car guide rail 104 while the other two openings 113 in each row can receive through fasteners for a second adjacent car guide rail (not shown). This means that each of the first, second and third interface brackets 110a, 110b, 114 forms a connecting plate for vertically connecting together adjacent guide rails. This is seen in FIG. 4, described further below. In this example, there is no need for separate fishplates to vertically connect together adjacent guide rails. Furthermore, the interface brackets 110a, 110b, 114 now fasten directly onto the guide rails 104, 106, 108 rather than relying on intervening clamps as described above in relation to the prior art of FIG. 1.

Referring to FIG. 2, it can be seen that the third interface bracket 114 is U-shaped, comprising a base plate 130 that forms the connecting plate and is arranged to face the guide rail bracket 102, and first and second side flanges 132a, 132b on opposed sides of the base plate 130 that space the base plate 130 away from the guide rail bracket 102. The first and second side flanges 132a, 132b extend away from the base plate 130 and terminate in first and second fastening plates 134a, 134b arranged to be fastened to the guide rail bracket 102.

Referring again to FIG. 2, it can be seen that the first and second interface brackets 110a, 110b are modified in shape in order to interface with the left and right counterweight guide rails 106, 108 while also integrating a fishplate function. In this example, the first and second interface brackets 110a, 110b are L-shaped, comprising a first plate 140a, 140b arranged to face the guide rail bracket 102 and a second plate 142a, 142b, substantially orthogonal to the first plate 140a, 140b, that forms the connecting plate and is arranged to face a base of the left or right counterweight guide rail 106, 108. The first and second interface brackets 110a, 110b further comprise a third plate 144a, 144b, substantially orthogonal to the first plate 140a, 140b and the second plate 142a, 142b. The third plate 144a, 144b extends away from the second plate 142a, 142b that forms the connecting plate. The L-shaped first and second interface brackets 110a, 110b are single metal parts with a bend formed between the first plate 140a, 140b and the second plate 142a, 142b, and another bend formed between the second plate 142a, 142b and the third plate 144a, 144b.

As can be seen most clearly for the second interface bracket 110b, the third plate 144b comprises a pair of openings for through fasteners 146 to attach the interface bracket 110b to a support bracket 148b. Each support bracket, for example the support bracket 148b seen in FIG. 2, is a foot configured to fixedly mount the guide rail bracket 102 to a wall, e.g. the wall of a hoistway or building. Such support brackets are provided at both ends of the guide rail bracket 102.

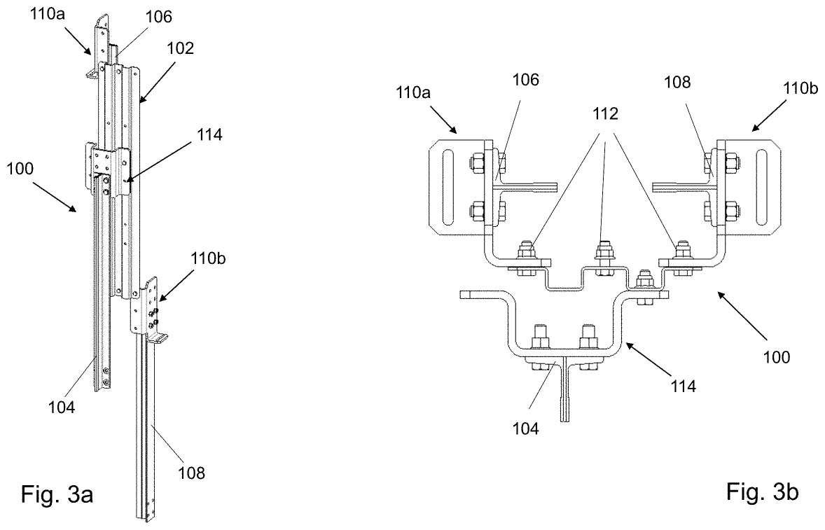

As shown in FIG. 3a, in a pre-assembled state of the guide rail assembly 100, the first, second and third interface brackets 110a, 110b, 114 are attached to the guide rail bracket 102 and to the guide rails 104, 106, 108 such that the guide rails 104, 106, 108 run substantially parallel to the guide rail bracket 102. FIG. 3b shows how this is achieved by attaching each of the interface brackets 110a, 110b, 114 to the guide rail bracket 102 by a single through fastener 112. The through fasteners 112 may be loosely attached so that the guide rails 104, 106, 108 can be rotated parallel to the guide rail bracket 102 once the guide rail assembly 100 is in situ. This pre-assembled state is compact for ease of transportation. The guide rail assembly 100 in this pre-assembled state may be hoisted more easily to a desired vertical position (e.g. in a hoistway) ready for installation.

As shown in FIG. 4, in an assembled state of the guide rail assembly 100, the first, second and third interface brackets 110a, 110b, 114 are attached to the guide rail bracket 102 and to the guide rails 104, 106, 108 such that the guide rails 104, 106, 108 run substantially perpendicular to the guide rail bracket 102. During installation, the guide rails 104, 106, 108 are rotated relative to the guide rail bracket 102, for example by loosening the through fasteners 112 seen in FIG. 3b and then re-tightening the through fasteners 112 once the guide rails 104, 106, 108 are perpendicular to the guide rail bracket 102. Then additional through fasteners 112 are employed to further attach the interface brackets 110a, 110b, 114 to the guide rail bracket 102. After the guide rail assembly has been unfolded, adjacent first and second left counterweight guide rails 106 are attached to the first interface bracket 110a so as to be vertically connected together, adjacent first and second right counterweight guide rails 108 are attached to the second interface bracket 110b so as to be vertically connected together, and adjacent first and second car guide rails 104 are attached to the third interface bracket 114 so as to be vertically connected together. No additional fishplates are required.

The guide rails disclosed herein have been described, by way of example, as standard T-profile guide rails i.e. wherein the guide rail includes a base and a blade extending therefrom. However, it will be appreciated that the present disclosure is not limited to T-profile guide rails and may be applied to guide rails of any profile. The guide rails may be monolithic, e.g. rigid steel guide rails, or formed of metal sheet, or made in any other suitable way as known to the skilled person.

It will be appreciated by those skilled in the art that the present disclosure has been illustrated by describing one or more specific examples thereof, but is not limited to these aspects; many variations and modifications are possible, within the scope of the accompanying claims.

What is claimed is:

1. A guide rail bracket assembly for connecting a car guide rail (104) to a pair of left and right counterweight guide rails (106,108) in an elevator system, the guide rail bracket assembly comprising:
a guide rail bracket (102) for horizontally connecting the car guide rail (104) to the pair of left and right counterweight guide rails (106, 108), the guide rail bracket (102) comprising a first end portion (103) for attachment to the left counterweight guide rail (106), a second end portion (105) for attachment to the right counterweight guide rail (108), and an intermediate portion (107) for attachment to the car guide rail (104);
a first interface bracket (110a) for attaching the first end portion (103) to the left counterweight guide rail (106), a second interface bracket (110b) for attaching the second end portion (105) to the right counterweight guide rail (108), and a third interface bracket (114) for attaching the intermediate portion (107) to the car guide rail (104);
wherein at least one of the first, second and third interface brackets (110a, 110b, 114) forms a connecting plate (142a, 142b, 130) for vertically connecting together adjacent guide rails.

2. A guide rail bracket assembly according to claim 1, wherein each of the first, second and third interface brackets (110a, 110b, 114) forms a connecting plate for vertically connecting together adjacent guide rails.

3. A guide rail bracket assembly according to claim 1, wherein the connecting plate (142a, 142b, 130) comprises at least four openings (113), each opening (113) arranged to receive a through fastener (112) for direct attachment of the left counterweight guide rail (106), right counterweight guide rail (108) or car guide rail (104) to its respective interface bracket (110a, 110b, 114).

4. A guide rail bracket assembly according to claim 1, wherein the first and second interface brackets (110a, 110b) are L-shaped, comprising a first plate (140a, 140b) arranged to face the guide rail bracket (102) and a second plate (142a, 142b), substantially orthogonal to the first plate (140a, 140b), the second plate (142a, 142b) forming the connecting plate and arranged to face a base of the left or right counterweight guide rail (106, 108).

5. A guide rail bracket assembly according to claim 4, wherein the first and second interface brackets (110a, 110b) further comprise a third plate (144a, 144b), substantially orthogonal to the first plate (140a, 140b) and the second plate (142a, 142b), the third plate (144a, 144b) extending away from the second plate (142a, 142b) that forms the connecting plate.

6. A guide rail bracket assembly according to claim 5, wherein the third plate (144a, 144b) comprises one or more openings for through fasteners (146) to attach the respective first or second interface bracket (110a, 110b) to a support bracket (148b).

7. A guide rail bracket assembly according to claim 1, further comprising a support bracket (148b) configured to fixedly mount the guide rail bracket (102) to a wall.

8. A guide rail bracket assembly according to claim 7, wherein the support bracket comprises a first support bracket attached to the first interface bracket (110a) and a second support bracket (148b) attached to the second interface bracket (110b).

9. A guide rail bracket assembly according to claim 1, wherein the third interface bracket (114) is U-shaped, comprising a base plate (130) that forms the connecting plate and is arranged to face the guide rail bracket (102), and first and second side flanges (132a, 132b) on opposed sides of the base plate (130) that space the base plate (130) away from the guide rail bracket (102).

10. A guide rail bracket assembly according to claim 9, wherein the first and second side flanges (132a, 132b) extend away from the base plate (130) and terminate in first and second fastening plates (134a, 134b) arranged to be fastened to the guide rail bracket (102).

11. A guide rail assembly (100) comprising:
the guide rail bracket assembly of claim 1;
a left counterweight guide rail (106) attached to the first interface bracket (110a);
a right counterweight guide rail (108) attached to the second interface bracket (110b); and
a car guide rail (104) attached to the third interface bracket (114);
wherein the first, second and third interface brackets (110a, 110b, 114) are attached to the guide rail bracket (102).

12. A guide rail assembly (100) according to claim 11, wherein at least one of the left counterweight guide rail (106), right counterweight guide rail (108) and car guide rail (104) is directly attached to its respective interface bracket (110a, 110b, 114) by a through fastener (112).

13. A guide rail assembly according to claim 11, wherein:
in a pre-assembled state, the first, second and third interface brackets (110a, 110b, 114) are attached to the guide rail bracket (102) and to the guide rails (104, 106, 108) such that the guide rails run substantially parallel to the guide rail bracket, and
in an assembled state, the first, second and third interface brackets (110a, 110b, 114) are attached to the guide rail bracket (102) and to the guide rails (104, 106, 108) such that the guide rails run substantially perpendicular to the guide rail bracket.

14. A guide rail assembly according to claim 11, wherein:
adjacent first and second left counterweight guide rails (106) are attached to the first interface bracket (110a) so as to be vertically connected together; and/or
adjacent first and second right counterweight guide rails (108) are attached to the second interface bracket (110b) so as to be vertically connected together; and/or
adjacent first and second car guide rails (104) are attached to the third interface bracket (114) so as to be vertically connected together.

15. A method of installing guide rails in an elevator system, comprising:
providing a guide rail assembly in a pre-assembled state, the guide rail assembly comprising a guide rail bracket attached to first, second and third interface brackets, the first interface bracket attached to a left counterweight guide rail, the second interface bracket attached to a right counterweight guide rail, and the third interface bracket attached to a car guide rail, wherein the guide rail bracket and the guide rails are attached to the interface brackets such that the guide rails run substantially parallel to the guide rail bracket; and
assembling the guide rail bracket to horizontally connect the car guide rail to the left and right counterweight guide rails by further attaching the guide rail bracket to the first, second and third interface brackets and further attaching the guide rails to the first, second and third interface brackets such that the guide rails run substantially perpendicular to the guide rail bracket.
